(19) United States
(12) Patent Application Publication
(10) Pub. No.: US 2020/0053702 A1
(43) Pub. Date: Feb. 13, 2020

(54) METHOD AND APPARATUS FOR PERFORMING SIDELINK COMMUNICATION IN WIRELESS COMMUNICATION SYSTEMS

(71) Applicant: FG Innovation Company Limited, Tuen Mun (HK)

(72) Inventors: YU-HSIN CHENG, Hsinchu (TW); YUNG-LAN TSENG, Hsinchu (TW); HUNG-CHEN CHEN, Hsinchu (TW); CHIE-MING CHOU, Hsinchu (TW)

(21) Appl. No.: 16/535,494

(22) Filed: Aug. 8, 2019

Related U.S. Application Data
(60) Provisional application No. 62/716,612, filed on Aug. 9, 2018.

(51) Int. Cl. H04W 72/04

(52) U.S. Cl. CPC H04W 72/042

(57) ABSTRACT

A method, performed by a user equipment (UE), includes receiving, from a base station (BS), a Radio Resource Control (RRC) configuration containing a carrier-specific Bandwidth Part (BWP) configuration; receiving, from the BS, Downlink Control Information (DCI) indicating a Sidelink (SL) BWP associated with the carrier-specific BWP configuration in a carrier; and performing SL operations on the SL BWP based on the carrier-specific BWP configuration.

### CROSS-REFERENCE TO RELATED APPLICATION(S)

The present application claims the benefit of and priority to a provisional U.S. Patent Application Ser. No. 62/716,612, filed on Aug. 9, 2018, entitled “Method and Apparatus for downlink control information indicator in Vehicle communication,” with Attorney Docket No. US74707 (hereinafter referred to as “US74707 application”). The disclosure of the US74707 application is hereby incorporated fully by reference into the present application.

### FIELD

The present disclosure generally relates to wireless communications, and more particularly, to methods and apparatuses for performing Sidelink (SL) communications in a wireless communication system (e.g., a Vehicle-to-everything (V2X) communication system).

### BACKGROUND

Various efforts have been made to improve different aspects of wireless communications (e.g., data rate, latency, reliability, mobility, etc.) for the next generation (e.g., 5G New Radio (NR)) wireless communication systems. Among these efforts, one area of interest for further development in the next generation wireless communication systems is Device-to-Device (D2D) communications, which may include V2X and Vehicle-to-Vehicle (V2V) communications. In D2D communications, the devices may communicate directly with each other via SL connections.

In order to support advanced D2D (e.g., V2X) services, the next generation wireless communication systems may need to meet certain requirements. For example, an NR wireless communication system may need to have a flexible design to support V2X services with low latency and high reliability requirements. However, an efficient signaling mechanism related to SL communications has not been introduced.

Therefore, there is a need in the art for methods and apparatuses for performing SL communications in a V2X system.

### SUMMARY

The present disclosure is directed to methods and apparatuses for performing SL communications in a wireless communication system.

According to an aspect of the present disclosure, a user equipment (UE) is provided. The UE includes one or more non-transitory computer-readable media having computer-executable instructions embodied thereon and at least one processor coupled to the one or more non-transitory computer-readable media. The at least one processor is configured to execute the computer-executable instructions to receive, from a base station (BS), a Radio Resource Control (RRC) configuration containing a carrier-specific Bandwidth Part (BWP) configuration, receive, from the BS, Downlink Control Information (DCI) indicating an SL BWP associated with the carrier-specific BWP configuration in a carrier; and perform SL operations on the SL BWP based on the carrier-specific BWP configuration.

According to another aspect of the present disclosure, a method performed by a UE is provided. The method includes receiving, from a BS, an RRC configuration containing a carrier-specific BWP configuration, receiving, from the BS, DCI indicating an SL BWP associated with the carrier-specific BWP configuration in a carrier, and performing SL operations on the SL BWP based on the carrier-specific BWP configuration.

### BRIEF DESCRIPTION OF THE DRAWINGS

Aspects of the present disclosure are best understood from the following detailed description when read with the accompanying figures. Various features are not drawn to scale. Dimensions of various features may be arbitrarily increased or reduced for clarity of discussion.

FIG. 1 is a schematic diagram illustrating beam operations of a V2X system, in accordance with example implementations of the present disclosure.

FIG. 2 is a sequence diagram illustrating a procedure for a UE to perform SL communications in a wireless communication system, in accordance with example implementations of the present disclosure.

FIG. 3 is a flowchart for a method of choosing an MCS table performed by a UE, in accordance with example implementations of the present disclosure.

FIG. 4 is a block diagram illustrating a node for wireless communication, in accordance with various aspects of the present disclosure.

### DETAILED DESCRIPTION

The following description contains specific information pertaining to example implementations in the present disclosure. The drawings in the present disclosure and their accompanying detailed description are directed to merely example implementations. However, the present disclosure is not limited to merely these example implementations. Other variations and implementations of the present disclosure will occur to those skilled in the art. Unless noted otherwise, like or corresponding elements among the figures may be indicated by like or corresponding reference numerals. Moreover, the drawings and illustrations in the present disclosure are generally not to scale and are not intended to correspond to actual relative dimensions.

For the purpose of consistency and ease of understanding, like features may be identified (although, in some examples, not shown) by the same numerals in the example figures. However, the features in different implementations may be differed in other respects, and thus shall not be narrowly confined to what is shown in the figures.

The description uses the phrases “in one implementation,” or “in some implementations,” which may each refer to one or more of the same or different implementations. The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series and the equivalent. The expression “at least one of A, B and C” or “at least one of the following: A, B and C” means “only A, or only B, or only C, or any combination of A, B and C.”

Additionally, for the purposes of explanation and non-limitation, specific details, such as functional entities, techniques, protocols, standard, and the like are set forth for providing an understanding of the described technology. In other examples, detailed description of well-known methods, technologies, systems, architectures, and the like are omitted so as not to obscure the description with unnecessary details.

Persons skilled in the art will immediately recognize that any network function(s) or algorithm(s) described in the present disclosure may be implemented by hardware, software or a combination of software and hardware. Described functions may correspond to modules which may be software, hardware, firmware, or any combination thereof. The software implementation may comprise computer executable instructions stored on computer readable medium such as memory or other type of storage devices. For example, one or more microprocessors or general-purpose computers with communication processing capability may be programmed with corresponding executable instructions and carry out the described network function(s) or algorithm(s). The microprocessors or general-purpose computers may be formed of Applications Specific Integrated Circuitry (ASIC), programmable logic arrays, and/or using one or more Digital Signal Processor (DSPs). Although some of the example implementations described in this specification are oriented to software installed and executing on computer hardware, nevertheless, alternative example implementations implemented as firmware or as hardware or combination of hardware and software are well within the scope of the present disclosure.

The computer readable medium includes but is not limited to Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture (e.g., a Long Term Evolution (LTE) system, an LTE-Advanced (LTE-A) system, an LTE-Advanced Pro system, or a 5G New Radio (NR) Radio Access Network (RAN)) typically includes at least one Base Station (BS), at least one User Equipment (UE), and one or more optional network elements that provide connection towards a network. The UE communicates with the network (e.g., a Core Network (CN), an Evolved Packet Core (EPC) network, an Evolved Universal Terrestrial Radio Access Network (E-UTRAN), a 5G Core (5GC), or an internet), through a RAN established by one or more BSs.

It should be noted that, in the present application, a UE may include, but is not limited to, a mobile station, a mobile terminal or device, a user communication radio terminal. For example, a UE may be a portable radio equipment, which includes, but is not limited to, a mobile phone, a tablet, a wearable device, a sensor, a vehicle, or a Personal Digital Assistant (PDA) with wireless communication capability. The UE is configured to receive and transmit signals over an air interface to one or more cells in a radio access network.

A BS may be configured to provide communication services according to at least one of the following Radio Access Technologies (RATs): Worldwide Interoperability for Microwave Access (WiMAX), Global System for Mobile communications (GSM, often referred to as 2G), GSM Enhanced Data rates for GSM Evolution (EDGE) Radio Access Network (GERAN), General Packet Radio Service (GRPS), Universal Mobile Telecommunication System (UMTS, often referred to as 3G) based on basic Wideband-Code Division Multiple Access (W-CDMA), High-Speed Packet Access (HSPA), LTE, LTE-A, eLTE (evolved LTE, e.g., LTE connected to 5GC), NR (often referred to as 5G), and/or LTE-A Pro. However, the scope of the present application should not be limited to the above-mentioned protocols.

A BS may include, but is not limited to, a node B (NB) as in the UMTS, an evolved Node B (eNB) as in the LTE or LTE-A, a Radio Network Controller (RNC) as in the UMTS, a Base Station Controller (BSC) as in the GSM/GERAN, a ng-eNB as in an Evolved Universal Terrestrial Radio Access (E-UTRA) BS in connection with the 5GC, a next generation Node B (gNB) as in the 5G-RAN, and any other apparatus capable of controlling radio communication and managing radio resources within a cell. The BS may serve one or more UEs through a radio interface.

The BS is operable to provide radio coverage to a specific geographical area using a plurality of cells forming the radio access network. The BS supports the operations of the cells. Each cell is operable to provide services to at least one UE within its radio coverage. More specifically, each cell (often referred to as a serving cell) provides services to serve one or more UEs within its radio coverage (e.g., each cell schedules the downlink and optionally uplink resources to at least one UE within its radio coverage for downlink and optionally uplink packet transmissions). The BS can communicate with one or more UEs in the radio communication system through the plurality of cells. A cell may allocate Sidelink (SL) resources for supporting Proximity Service (ProSe) or Vehicle to Everything (V2X) service. Each cell may have overlapped coverage areas with other cells.

As discussed above, the frame structure for NR is to support flexible configurations for accommodating various next generation (e.g., 5G) communication requirements, such as Enhanced Mobile Broadband (eMBB), Massive Machine Type Communication (mMTC), Ultra-Reliable and Low-Latency Communication (URLLC), while fulfilling high reliability, high data rate and low latency requirements. The Orthogonal Frequency-Division Multiplexing (OFDM) technology as agreed in the 3^{rd} Generation Partnership Project (3GPP) may serve as a baseline for NR waveform. The scalable OFDM numerology, such as the adaptive sub-carrier spacing, the channel bandwidth, and the Cyclic Prefix (CP) may also be used. Additionally, two coding schemes are considered for NR: (1) Low-Density Parity-Check (LDPC) code and (2) Polar Code. The coding scheme adaption may be configured based on the channel conditions and/or the service applications.

Moreover, it is also considered that in a transmission time interval TX of a single NR frame, a Downlink (DL) transmission data, a guard period, and an Uplink (UL) transmission data should at least be included, where the respective portions of the DL transmission data, the guard period, the UL transmission data should also be configurable, for example, based on the network dynamics of NR. In addition, SL resources may also be provided in an NR frame to support ProSe services or V2X services.

In addition, the terms “system” and “network” herein may be used interchangeably. The term “and/or” herein is only an association relationship for describing associated objects, and represents that three relationships may exist. For example, A and/or B may indicate that: A exists alone, A and B exist at the same time, or B exists alone. In addition, the character “/” herein generally represents that the former and latter associated objects are in an “or” relationship.

As discussed above, the frame structure for NR is to support flexible configurations for accommodating various next generation (e.g., 5G) communication requirements, such as Enhanced Mobile Broadband (eMBB), Massive Machine Type Communication (mMTC), Ultra-Reliable and Low-Latency Communication (URLLC), while fulfilling high reliability, high data rate and low latency requirements. The Orthogonal Frequency-Division Multiplexing (OFDM) technology as agreed in the 3rd Generation Partnership Project (3GPP) may serve as a baseline for NR waveform. The scalable OFDM numerology, such as the adaptive sub-carrier spacing, the channel bandwidth, and the Cyclic Prefix (CP) may also be used. Additionally, two coding schemes are considered for NR: (1) Low-Density Parity-Check (LDPC) code and (2) Polar Code. The coding scheme adaption may be configured based on the channel conditions and/or the service applications.

Moreover, it is also considered that in a transmission time interval TX of a single NR frame, a downlink (DL) transmission data, a guard period, and an uplink (UL) transmission data should at least be included, where the respective portions of the DL transmission data, the guard period, the UL transmission data should also be configurable, for example, based on the network dynamics of NR. In addition, SL resources may also be provided in an NR frame to support ProSe services or V2X services.

In addition, the terms “system” and “network” herein may be used interchangeably. The term “and/or” herein is only an association relationship for describing associated objects and represents that three relationships may exist. For example, A and/or B may indicate that: A exists alone, A and B exist at the same time, and B exists alone. In addition, the character “I” herein generally represents that the former and latter associated objects are in an “or” relationship.

As noted above, an NR system may be expected to have a flexible design in support of services with low latency and high reliability requirements. The NR system may also be expected to have a higher system capacity and a better coverage than a legacy system. In addition, the flexibility of NR SL framework may allow easy extension of the NR system to support, for example, the future developments in advanced V2X services and other services.

In order to introduce beam-based operations for Frequency Range 1 (FR1) and Frequency Range 2 (FR2) common designs, some of the present implementations provide improved the content for a Downlink Control Information (DCI) message and/or a Sidelink Control Information (SCI) message.

Moreover, some V2X applications may require high reliability performances. Hence, some of the present implementations provide improved (e.g., having higher reliability) DCI transmissions, SCI transmissions and PSSCH transmissions, not only in time and frequency domains but also in spatial domain.

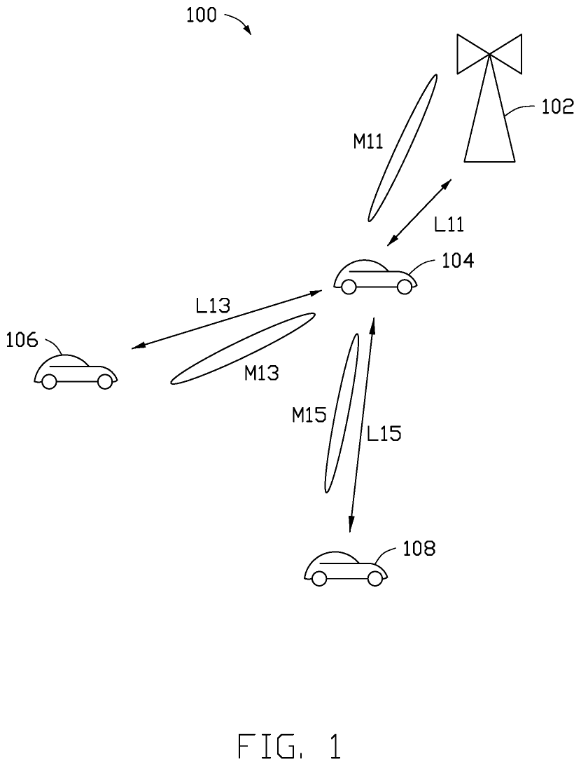

FIG. 1 is a schematic diagram illustrating beam operations of a V2X system, in accordance with example implementations of the present disclosure. As shown in FIG. 1, the V2X system 100 may include a BS 102 and several UEs (e.g., the UEs 104, 106 and 108). It should be noted that even though three UEs 104, 106 and 108 are included in the example implementation illustrated in FIG. 1, any number of UEs may communication with each other in some other implementations of the present application.

The UE 104 may communicate with the BS 102 via an Uplink (UL) and/or a Downlink (DL) connection of a V2X-Uu interface L11. For example, the UE 104 may monitor a beam (or a Reference Signal (RS)) M11 on the V2X-Uu interface L11 based on the beam information configured in a Control Resource Set (CORESET) configuration. The UE 104 may further communicate with other UEs 106 and 108 via SL PC5 interfaces L13 and L15, respectively. In addition, the UE 104 may apply beamforming technology to generate beams M13 and M15 to perform directional transmissions and receptions with the UEs 106 and 108.

Techniques related to control mechanisms of a V2X system are now described in the following.

Beam-Related DCI Messages

In some of the present implementations, DCI (e.g., DCI format NR_V or DCI_NR_V) for scheduling a Physical Sidelink Control Channel (PSCCH) may contain at least one of beam related information, a Transmission Configuration Indicator (TCI) state indicator(s), and QCL information. For example, the DCI may include a TCI state indicator (e.g., TCI state #1) or a Reference Signal (RS) index (e.g., Channel Status Information (CSI)-RS resource #1 or Sounding Reference Signal (SRS) resource #1).

In some of the present implementations, a UE may transmit a PSCCH through the same spatial domain filter as that for receiving or transmitting the RS(s) indicated by the DCI.

In some of the present implementations, a UE may apply the most recent spatial domain filter (for receiving or transmitting the indicated RSs) to transmit a PSCCH.

In some of such implementations, a UE may transmit a Physical Sidelink Shared Channel (PSSCH) which is scheduled by the PSCCH through the same spatial domain filter indicated by the DCI.

In some of the present implementations, a UE may apply a spatial domain filter which is used for receiving a PDCCH containing the DCI to perform SL operations (e.g., transmitting or receiving a PSCCH and/or a PSSCH). That is, the UE may transmit a PSCCH and/or a PSSCH through the same spatial domain filter as that for receiving the CORESET containing the DCI. For example, a BS may configure Synchronization Signal Block (SSB) index #1 for CORESET #1, and a UE may receive the DCI in a search space which is associated with the CORESET #1. In such a case, the UE may apply the same spatial domain filter, as that for receiving the SSB index #1, to transmit the PSCCH scheduled by the received DCI.

In some of the present implementations, the UE may apply the same spatial domain filter as that for receiving a CORESET to transmit an SL physical channel (e.g., a PSCCH or a PSSCH) if the received DCI does not include beam related information, QCL information, and an RS index.

In some of the present implementations, a BS may transmit an indicator through an RRC signaling to indicate to a UE whether to transmit a PSCCH through the same spatial domain filter as that for receiving the CORESET. In some of such implementations, the UE may transmit the PSSCH (scheduled by the PSCCH) through the same spatial domain filter as indicated by the DCI.

In some of the present implementations, if a UE receives DCI that does not contain beam related information, the UE may select a spatial domain filter to use based on a previous setting. For example, if in subframe #1, the UE receives first DCI that indicates to the UE to transmit V2X transmissions through the same spatial domain filter as that for receiving SSB #3 (because the spatial domain filter information contained in the DCI is SSB #3), the UE may apply the spatial domain filter (used for receiving SSB #3) to transmit a PSCCH. Then, in subframe #20, if the UE receives second DCI that does not contain beam related information (e.g., a reserved bitmap of spatial domain filter information), or the second DCI does not indicate a valid beam (e.g., the UE has not yet received an indicated RS), the UE may still apply the same spatial domain filter as that for receiving SSB #3.

In some of the present implementations, a UE may determine whether to transmit or receive a PSCCH and a PSSCH (scheduled by the PSCCH) through the same spatial domain filter based on a same-beam indicator. Such a same-beam indicator may be contained in an RRC configuration, a pre-configuration parameter (e.g., defined by the 3GPP specifications), or BS-broadcast system information (e.g., the system information broadcast by a BS). In some of the present implementations, the same-beam indicator may be configured per an anchor carrier basis or per a resource pool basis. For example, upon receiving the DCI (which contains spatial domain filter information and PSCCH/PSSCH resource information), a UE may determine whether to apply the same spatial domain filter for both of the PSSCH and the PSCCH based on the same-beam-indicator (which is configured for the scheduled resource pool or anchor carrier). For example, if the DCI indicates to a UE to transmit a PSCCH in cell #3 through the same spatial domain filter as that for receiving SSB #2, the UE may assume that the PSCCH and a scheduling PSSCH (e.g., the PSSCH which is scheduled by the PSCCH) may be transmitted or received based on the same spatial domain filter as that for receiving SSB #2 when the same-beam-indicator (which is configured for a subchannel contained in cell #3) indicates “true.”

RS for NR V2X

In some of the present implementations, the DCI (e.g., DCI format NR_V or DCI_NR_V) for scheduling a PSCCH may be used to indicate Demodulation Reference Signal (DMRS) related information (e.g., DMRS settings). The DMRS related information may include at least one of DMRS sequence generation information, the number of DMRS symbols, a DMRS port index, a DMRS port group index, and a type of a DMRS pattern (e.g., DMRS type 1 or DMRS type 2). Example DMRS settings are represented in the form of a table as shown below.

TABLE 1

| | Number of DMRS symbols | Type of DMRS patterns |
|---|---|---|
| 0 | 1 | 1 |
| 1 | 1 | 2 |
| 2 | 2 | 1 |
| 3 | 2 | 2 |
| 4 | 3 | 1 |
| . | . | . |
| . | . | . |
| . | . | . |
| 7 | 4 | 2 |

As shown in Table 1, the DMRS setting table (e.g., Table 1) may include a plurality of DMRS setting entries, with each being indexed by a number (e.g., 0, 1, . . . , 7) and associated with a set of DMRS related information parameters (e.g., a particular number of DMRS symbols and a particular type of DMRS patterns). Different types of DMRS patterns may correspond to different time/frequency resource allocations of the DMRS(s) transmitted in a predefined time period.

In some of the present implementations, the DMRS setting table may be contained in a pre-configuration, an RRC configuration, or BS-broadcast system information. A BS may transmit the DCI (containing an index of a DMRS setting table) to indicate to a UE that a DMRS setting should be applied to one PSCCH transmission or multiple PSCCH transmissions (e.g., multiple PSCCH repetitions). In some of the present implementations, a BS may transmit the DCI (containing multiple indices of a DMRS setting table) to indicate to a UE that multiple DMRS settings should be applied to one or more PSCCH transmissions, where the indices of the DMRS setting table and the plurality of PSCCH transmissions may have a one-to-one mapping relationship. For example, the DCI may contain two indices “1” and “7” of the DMRS setting table shown above in Table 1, and the number of PSCCH repetitions may be “2.” In response to receiving such DCI, the UE may, according to Table 1 for example, assume that one DMRS setting for the first PSCCH transmission is to transmit one DMRS symbol based on DMRS type 2, while the other DMRS setting for the second PSCCH transmission is to transmit four DMRS symbols based on DMRS type 2.

In some of the present implementations, a PSCCH and a scheduling PSSCH (scheduled by the PSCCH) may apply the same DMRS setting indicated by the DCI.

In some of the present implementations, a DMRS setting indicated by the DCI may only be applied to a PSSCH, whereas the PSCCH (which schedules the PSSCH) may apply another DMRS setting which may be predefined, preconfigured, or indicated by the BS-broadcast system information. For example, a UE may apply a first DMRS setting (e.g., predefined in the 3GPP specifications or contained in a V2X pre-configuration parameter) for a PSCCH, and apply a second DMRS setting (which is indicated by DCI) to a scheduling PSSCH scheduled by the PSCCH. In addition, according to the first DMRS setting, the DMRS(s) in the PSCCH may occupy the first OFDM symbol based on DMRS type 1. According to the second DMRS setting, the UE may transmit the PSSCH with two additional DMRS symbols based on DMRS pattern type 1 (e.g., when the index of the DMRS setting table contained in the DCI is “2” for Table 1).

Tracking Reference Signals (TRSs) are RSs used for fine time and frequency measurement for channel estimation. In some of the present implementations, the DCI (e.g., DCI format NR_V or DCI_NR_V), which is used for scheduling a PSCCH, may also be used for indicating TRS related information (e.g., TRS settings). For example, the TRS related information may include at least one of the following parameters: a TRS existence indicator for indicating whether a TRS is transmitted in a PSCCH and/or the scheduling PSSCH (scheduled by the PSCCH), TRS sequence generation information, a TRS port index, and a TRS pattern (e.g., the time and frequency domain information of the TRS) for a PSCCH and/or the scheduling PSSCH.

In some of the present implementations, a UE may be configured with a TRS setting table which may be contained in a pre-configuration parameter, an RRC configuration, or the BS-broadcast system information. The TRS setting table may include one or more indices with each index being associated with a particular TRS setting. A BS may transmit the DCI (containing an index of the TRS setting table) to indicate to a UE one TRS setting to be applied to one or more PSCCH and/or PSSCH transmissions. In some of the present implementations, a BS may transmit DCI (containing multiple indices of the TRS setting table) to indicate to a UE multiple TRS settings to be applied to one or more PSCCH and/or PSSCH transmissions.

In some of the present implementations, the PSCCH and the scheduling PSSCH (scheduled by the PSCCH) may apply the same TRS setting indicated by the DCI.

In some of the present implementations, the DCI may contain a priority indicator and/or a reliability indicator. After receiving the DCI, a UE may determine the TRS pattern or the existence of the TRS(s) according to the priority indicator and/or the reliability indicator. For example, if the value of the reliability indicator (e.g., a Prose Per Packet Reliability (PPPR)-related indicator or destination-Identity (ID)-related information) in the DCI exceeds a pre-configured, RRC-configured, or BS-broadcast threshold, the UE may consider that the SL service packet is relatively important. In such a case, the UE may transmit a TRS which is associated with the PSSCH and/or the PSCCH, where the TRS pattern may be determined by a pre-configuration parameter (defined by the 3GPP specifications for example). In some of the present implementations, if a UE does not receive the DCI for scheduling a PSCCH, the UE may determine whether to transmit a TRS based on the priority and/or reliability level of the logical channel and/or the radio bearer associated with the SL packet.

In some implementations of the present disclosure, PTRS related information (or a PTRS setting) may be indicated by the DCI (e.g., DCI format NR_V, DCI_NR_V) which is used for scheduling a PSCCH. The PTRS may be an RS used for phase tracking. In some implementations of the present disclosure, the PTRS related information may include at least one of the following: a PTRS existence indicator for indicating whether a PTRS in transmitted in a PSCCH and/or the scheduling PSSCH (scheduled by the PSCCH), PTRS sequence generation information, a PTRS port index, and a PTRS pattern (e.g., the time and frequency domain information of the PTRS) for a PSCCH and/or the scheduling PSSCH.

In some implementations of the present disclosure, a UE may be configured with a PTRS setting table which may be contained in a pre-configuration parameter (e.g., defined by 3GPP technical specifications), an RRC configuration (e.g., an SL-RRC configuration or a Uu-RRC configuration), or the BS-broadcast system information. The PTRS setting table may include one or more indices with each index being associated with a particular PTRS setting. In some implementations of the present disclosure, a BS may transmit DCI (containing an index of the PTRS setting table) to indicate to a UE that one PTRS setting should be applied to one or more PSCCH and/or PSSCH transmissions. In some of the present implementations, a BS may transmit the DCI (containing multiple indices of the TRS setting table) to indicate to a UE that multiple PTRS settings should be applied to one or more PSCCH and/or PSSCH transmissions.

In some of the present implementations, the PSCCH and the scheduling PSSCH (scheduled by the PSCCH) may apply the same PTRS setting indicated by the DCI.

In some of the present implementations, the DCI may contain a priority indicator and/or a reliability indicator. In response to receiving the DCI, a UE may determine the PTRS pattern or the existence of the PTRS(s) according to the priority indicator and/or the reliability indicator. For example, if the value of the reliability indicator (e.g., a PPPR related indicator or destination-ID-related information) in the DCI exceeds a pre-configured, RRC-configured, or BS-broadcast threshold, the UE may consider that the SL service packet is relatively important. In such a case, the UE may transmit a PTRS in the PSSCH and/or the PSCCH (which schedules the PSSCH), where the PTRS pattern may be determined by a pre-configuration parameter (defined by the 3GPP specifications for example). In some of the present implementations, if a UE does not receive the DCI for scheduling a PSCCH, the UE may determine whether to transmit a PTRS based on the priority and/or reliability level of the logical channel and/or the radio bearer associated with the SL packet. In some of the present implementations, a UE may determine whether to transmit a PTRS (or whether there is an index of the PTRS setting table in the DCI) based on the time/frequency location of a resource pool selected for transmission or reception. For example, if the DCI indicates to a UE to transmit a PSCCH in cell #2, or carrier #2, located in FR2, the UE may assume that there may be a PTRS indicator in the PSCCH (e.g., the PTRS indicator may be used to indicate the existence of a PTRS in the PSSCH), or there may be a PTRS transmitted in the PSCCH, or the DCI may contain an index of the PTRS setting table. Conversely, if the DCI indicates to a UE to transmit a PSCCH in a cell #3, or carrier #3, located in FR1, the UE may assume that there may be no PTRS indicator in the PSCCH, or there may not be a PTRS transmitted in the PSCCH, or the DCI may not contain an index of the PTRS setting table.

In some implementations of the present disclosure, a UE may obtain an RS setting (e.g., a DMRS/PTRS/TRS setting) of each resource pool (or each anchor carrier) from an RRC configuration (e.g., an SL-RRC configuration or a Uu-RRC configuration), a pre-configuration parameter, or the BS-broadcast system information.

In some implementations of the present disclosure, an RRC configuration (e.g., an SL-RRC configuration or a Uu-RRC configuration) may include multiple RS settings for SL operations, and each of the RS settings may be configured per a resource pool basis or per an anchor carrier basis. In some of the present implementations, the RS settings may include at least one of a DMRS setting, a PTRS setting, and a TRS setting. Each of the RS settings (e.g., the DMRS/PTRS/TRS setting) may include at least one of sequence generation information, the number of symbols, a port index, a port group index, a type of pattern, and the time/frequency domain resource location information for the corresponding RS (e.g., the DMRS, the PTRS, or the TRS).

In some implementations of the present disclosure, a UE may update (or override) an RS pattern (e.g., a TRS pattern or a DMRS pattern) contained in an RRC configuration (e.g., an SL-RRC configuration or a Uu-RRC configuration) based on the received DCI. For example, the TRS pattern may include time and frequency domain resource allocations of a set of TRSs, and the DMRS pattern may include time and frequency domain resource allocations of a set of DMRSs.

In some implementations of the present disclosure, for each resource pool, the DCI may be used to override an RS setting originally defined in an RRC configuration (e.g., an SL-RRC configuration or a Uu-RRC configuration), a pre-configuration parameter, or BS-broadcast system information. For example, if a DMRS type in an RRC configuration (e.g., an SL-RRC configuration or a Uu-RRC configuration) for resource pool #1 is configured as “type 1,” then when a UE receives the DCI that indicates to the UE to apply DMRS type 2, the UE may transmit DMRS(s) in a PSCCH and/or a PSSCH (scheduled by the PSCCH) based on DMRS type 2, instead of based on DMRS type 1 defined in the RRC configuration.

BWP Related (or Subcarrier Spacing (SCS) Related) DCI/RRC

In some of the present implementations, a resource pool configuration may include a BWP related configuration or an SCS related configuration (e.g., including at least one of TX parameters, a synchronization setting, an offset, gap, and a cyclic prefix). A UE may select a resource pool to transmit or receive a PSSCH/PSCCH based on a priority indicator (e.g., a ProSe Per-Packet Priority (PPPP)) and a reliability indicator (e.g., a PPPR) in DCI, and the BWP/SCS related configuration.

In some of the present implementations, the BWP/SCS related configuration (e.g., including at least one of TX parameters, a synchronization setting, an offset, gap, and a cyclic prefix) may be a carrier-specific configuration. That is, the BWP/SCS related configuration may be the same for one specific anchor carrier for V2X communications.

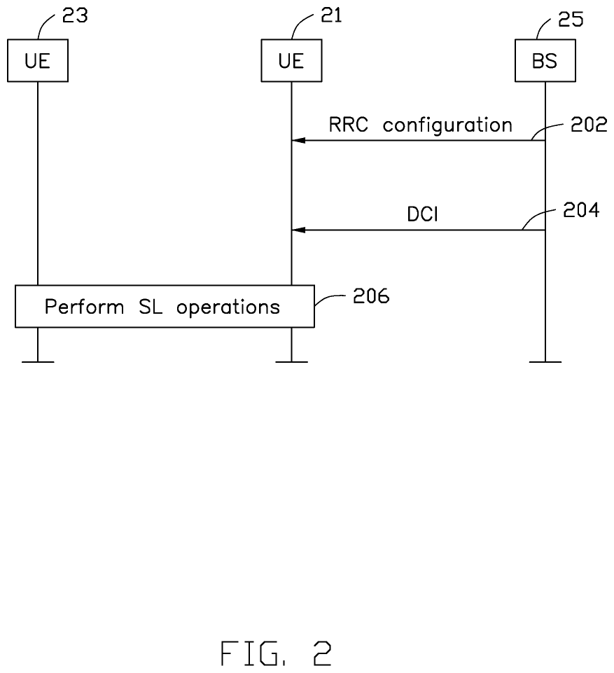

FIG. 2 is a sequence diagram illustrating a procedure for a UE to perform SL communications in a wireless communication system, in accordance with example implementations of the present disclosure. As shown in FIG. 2, the wireless communication system may include a UE 21, a UE 23, and a BS 25. It should be noted that the number of the communication devices (e.g., the UEs) shown in FIG. 2 is for illustrative purposes only, and not intended to limit the scope of the present invention.

In action 202, the UE 21 may receive an RRC configuration (e.g., an SL-RRC configuration or a Uu-RRC configuration) from the BS 25. The RRC configuration may contain a carrier-specific BWP configuration. As described above, the carrier-specific BWP configuration (e.g., including at least one of TX parameters, a synchronization setting, an offset, gap, and a cyclic prefix) may be the same for the BWP(s) on a specific (anchor) carrier for V2X communications.

In action 204, the UE 21 may receive DCI from the BS 25. The DCI may indicate to the UE 21 an SL BWP (associated with the carrier-specific BWP configuration) in a carrier (e.g., an anchor carrier corresponding to the carrier-specific BWP configuration).

In action 206, the UE 21 may perform SL operations (e.g., with the UE 23) on the SL BWP based on the carrier-specific BWP configuration.

In some of the present implementations, the MAC entity may determine the priority of different available anchor carriers for V2X communications according to a PPPP and/or a PPPR.

In some of the present implementations, a timing offset between a Direct Frame Number (DFN) (e.g., the timing information that a UE obtains from a Global Navigation Satellite System (GNSS)) and a System Frame Number (SFN) may be an SCS-specific parameter or a BWP-specific parameter. For example, a unit of time of the timing offset when the SCS of a resource pool is 30 Kilo Hertz (KHz) may be different from a unit of time of the timing offset when the SCS of a resource pool is 15 KHz.

In some of the present implementations, the unit of time of the timing offset may be 1 millisecond (ms) when the SCS is 15 KHz, and the unit of time of the timing offset may reduce to 0.5 ms when the SCS is 30 KHz (e.g., for better synchronization). Based on a similar approach, the required time of sensing and the configurable time of sensing for different resource pools (or anchor carriers) with different SCSs may be different. The sensing described herein may include partial sensing, the sensing for measurement report(s), and the sensing for determining resources for transmitting a PSSCH. In some of the present implementations, the Channel Busy Ratio (CBR) and the Channel occupancy Ratio (CR) may be measured from subframe #[n-a] to subframe #[n-b] (e.g., “a” may be “100” and “b” may be “1” when the SCS is 15 KHz for CBR) if the CBR/CR is measured in subframe # n. In some of the present implementations, the length of sensing window may be different for different SCSs. For example, the above-described parameters, “a” and “b,” may be different for the resource pools (or anchor carriers) with different SCSs.

In some of the present implementations, the DCI may include an SCS indicator and/or a BWP indicator to indicate to a UE in which BWP or SCS the UE can transmit a PSSCH and/or a PSCCH. For example, if a UE receives DCI indicating that “the SCS is 30 KHz,” the UE may select a resource pool or an anchor carrier (based on the DCI) with an SCS of 30 KHz to transmit a PSCCH and/or a PSSCH. In some of such implementations, the UE may further treat the resource pool or the anchor carrier with an SCS of 30 KHz with a higher priority.

In some of the present implementations, the priority indicator contained in the DCI may be used to determine the BWP or SCS on which a UE may transmit a PSCCH and/or a PSSCH. For example, if a UE receives DCI that contains a priority indicator of “1,” the UE may first attempt to select resource pools with an SCS of 30 KHz to use. If such resource pools (with an SCS of 30 KHz) are insufficient, then the UE may attempt to use the resource pools with a lower SCS (e.g., an SCS of 15 KHz). In some of the present implementations, the MAC entity of the UE may perform a Logical Channel Prioritization (LCP) operation, in which each logical channel may be configured with a list of available SCSs (e.g., allowedSCS-List). For example, if a UE receives DCI that indicates to the UE to transmit a V2X physical channel by an SCS of “60 KHz,” only those logical channels having allowedSCS-List which contains an available SCS of “60 KHz” may be selected and allocated resources by the MAC-entity of the UE.

In some of the present implementations, in order to receive a PSCCH and a PSSCH, a UE may need to monitor all possible BWPs or SCSs in a resource pool or an anchor carrier. In some of the present implementations, the PSCCH BWP or SCS may be configured through an RRC configuration (e.g., an SL-RRC configuration or a Uu-RRC configuration), a pre-configuration parameter, or the broadcast system information, per a resource pool basis or per an anchor carrier basis. Hence, in some of such implementations, the BWP or SCS (indicated by the DCI) may only be applied for the PSSCH.

Group-Based DCI for V2X System

In some of the present implementations, group-based DCI may be used to schedule a PSSCH and/or a PSCCH to a group of UEs. For example, a UE may be configured with two different Radio Network Temporary Identifiers (RNTIs) for an NR-V2X service: one RNTI may be a UE-specific RNTI, and the other RNTI may be a UE-group-specific RNTI. When the UE decodes the DCI that is scrambled by the UE-group-specific RNTI, the UE may consider that the DCI is group-based DCI (e.g., DCI_NR_V_group). On the other hand, if the UE decodes DCI which is scrambled by the UE-specific RNTI, the UE may consider that the DCI is single-UE based DCI (e.g., DCI_NR_V). The content of these two DCIs may be different. For example, the group-based DCI may further contain a timing advance value or an SFN-DFN offset indicator compared to the single-UE based DCI.

Repetition Transmissions of PSCCH and/or PSSCH

In some of the present implementations, the DCI may include an indicator for determining a number of repetitions of an SL physical channel (e.g., a PSCCH or a PSSCH). For example, the DCI may contain a first channel repetition indicator (e.g., N_PSCCH_repetition) used for indicating the number of repetitions of a PSCCH. The first channel repetition indicator may also be used for indicating the number of repetitions of a PSSCH in some implementations. In another example, the DCI may contain a second channel repetition indicator (e.g., N_PSSCH_repetition) used for indicating the number of repetitions of a PSSCH.

In some of the present implementations, a UE may obtain a threshold which may be preconfigured in the UE or configured by the BS. For example, the threshold may be contained in an RRC configuration (e.g., an SL-RRC configuration or a Uu-RRC configuration), a pre-configuration parameter, or the BS-broadcast system information. The UE may further determine the number of repetitions of an SL physical channel (e.g., a PSCCH or a PSSCH) based on a comparison between the threshold and an indicator. In some of the present implementations, such an indicator may be a reliability indicator and/or a priority indicator contained in the DCI (e.g., DCI_NR_V) or the SCI for NR V2X (e.g., SCI_NR_V), and the number of repetitions of the SL physical channel may depend on the reliability indicator and/or the priority indicator. For example, if the reliability indicator in the DCI is “2,” which is lower than a threshold, a UE may repetitively transmit the PSCCH a preconfigured number of times (e.g., four times, including one initial PSCCH transmission and three PSCCH retransmissions). Conversely, if the reliability indicator in the DCI is larger than or equal to the threshold, the PSCCH may not be repetitively transmitted.

In some of the present implementations, the time gap between two adjacent PSSCH retransmissions may be indicated by a time gap indicator contained in SCI_NR_V. The time gap indicator may be used to indicate a time gap between the initial PSSCH transmission and the first PSSCH retransmission. In some of the present implementations, based on a similar approach, the time gap between two adjacent PSCCH retransmissions may be indicated by the DCI.

In some of the present implementations, the DCI may contain a spatial domain filter or a Quasi Co Location (QCL) parameter, and each PSCCH (re)transmission may apply the same spatial domain filter. In some of the present implementations, the PSCCH and the PSSCH (scheduled by the PSCCH) may apply the same spatial domain filter. For example, if the DCI indicates to a UE a spatial domain filter of “SSB #2,” and the number of repetitions is “4,” the UE may transmit the same PSCCH four times (four PSCCH repetitions). In such a case each PSCCH repetition may be transmitted through the same spatial domain filter as that for receiving SSB #2.

In some of the present implementations, the DCI may contain several spatial domain filters or QCL parameters for multiple PSSCH and/or PSCCH repetitions. The number of spatial domain filters or QCL parameters may be less than or equal to the number of repetitions of a PSSCH or a PSCCH. If these two numbers are equal, the UE may assume that the spatial domain filter(s) and the physical channel repetition(s) may have a one-to-one mapping relationship. In contrast, if these two numbers are not equal, the UE may assume that the spatial domain filter(s) may be allocated to the physical channel repetition(s) equally. For example, if the DCI indicates two spatial domain filters of “SSB #2” and “SSB #3,” and the number of physical channel repetitions is “4,” the first two PSCCH repetitions (e.g., including the initial PSCCH transmission and the first PSCCH retransmission) may be based on the spatial domain filter of “SSB #2,” and the last two PSCCH repetitions (e.g., including the second PSCCH retransmission and the third PSCCH retransmission) may be based on the spatial domain filter of “SSB #3.”

PSCCH and/or PSSCH Repetitions Indicated by DCI

In some of the present implementations, a Modulation Coding Scheme (MCS) table may be configured by a BS per a resource pool basis or per an anchor carrier basis. Such an MCS table may be contained in an RRC configuration (e.g., an SL-RRC configuration or a Uu-RRC configuration), a pre-configuration parameter, or the BS-broadcast system information. A UE may perform modulation and coding for an SL physical channel (e.g., a PSCCH or a PSSCH) based on the MCS table.

In some of the present implementations, the MCS table may be a resource pool-specific configuration. For example, some resource pools may be configured with a normal reliability MCS table (e.g., with a target Block Error Rate (BLER) of 1e-1), while some other resource pools may be configured with a high reliability MCS table (e.g., with a target BLER of 1e-5). In some of the present implementations, the MCS table may be an anchor carrier-specific configuration.

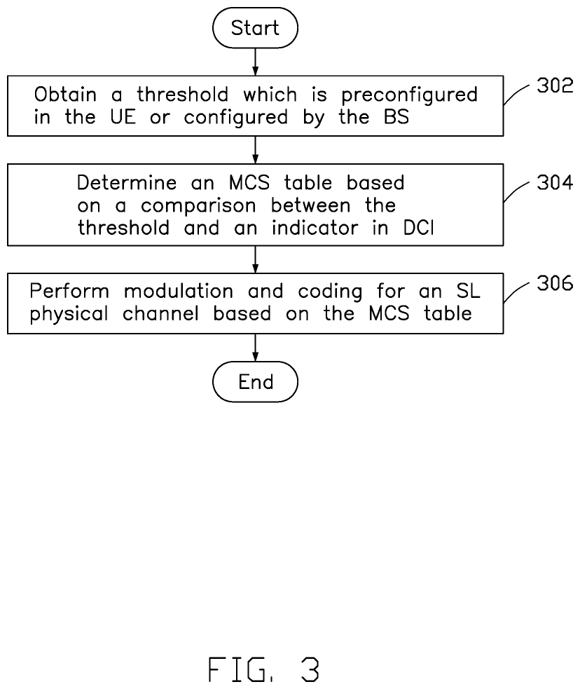

In some of the present implementations, a UE may decide which MCS table to apply for a PSSCH, based on an indicator in the DCI. FIG. 3 is a flowchart for a method of choosing an MCS table performed by a UE, in accordance with example implementations of the present disclosure. As shown in FIG. 3, in action 302, a UE may obtain a threshold which is preconfigured in the UE or configured by the BS. For example, the threshold may be contained in a pre-configuration parameter, an RRC configuration (e.g., an SL-RRC configuration or a Uu-RRC configuration), or the BS-broadcast system information. In action 304, the UE may determine an MCS table based on a comparison between the threshold and an indicator in the DCI. In action 306, the UE may perform modulation and coding for an SL physical channel based on the MCS table. In some of the present implementations, the indicator in the DCI may be a reliability indicator (e.g., a PPPR value). If the PPPR value of a data packet (e.g., the PPPR value is associated with a Logical Channel Group (LCG) of this data packet) is higher than or equal to the threshold (which may be a configurable value or a fixed value), the UE may use a high reliability MCS table to transmit the PSSCH. Otherwise, if the PPPR value of the data packet is less than the threshold, the UE may use a normal reliability MCS table to transmit the PSSCH.

In some of the present implementations, the DCI may contain an MCS table indicator (e.g., a 1-bit indicator, for which a “0” may indicate that a normal reliability MCS table may be used, and a “1” may indicate that a high reliability MCS table may be used) for indicating to a UE which MCS table is to be used for modulating/coding a PSSCH. For example, if a UE receives DCI that contains an MCS table indicator of “1,” the UE may transmit a PSSCH (on the resources scheduled by the DCI) that is modulated based on a high reliability MCS table.

In some of the present implementations, an MCS index of an MCS table may be configured per a resource pool basis. The MCS index may be contained in an RRC configuration (e.g., an SL-RRC configuration or a Uu-RRC configuration), a pre-configuration parameter or the BS-broadcast system information. In some of the present implementations, each resource pool may be associated with a plurality of MCS indices for different MCS tables. These MCS table indices may be contained in an RRC configuration (e.g., an SL-RRC configuration or a Uu-RRC configuration), a pre-configuration parameter, or the BS-broadcast system information. For example, an MCS index for normal reliability may be “10,” and another MCS index for high reliability may be “12.” In such a case, if a UE receives DCI that indicates to the UE to perform a high reliability transmission, the UE may apply a high reliability MCS with an MCS index of “12” to transmit a PSSCH.

In some of the present implementations, a UE may determine an MCS table based on a type of an RNTI scrambling the DCI, and perform modulation and coding for an SL physical channel based on the MCS table. For example, different types of RNTIs (e.g., SL-V-RNTI for a normal reliability MCS table, and SL-V-RNTI-U for a high reliability MCS table) may be used to scramble the DCI (if the DCI indicates to the UE to transmit a PSSCH based on the high reliability MCS table). If the UE receives the DCI that is scrambled by SL-V-RNTI-U, and the RRC configuration contains an MCS index of “20,” the UE may apply a high reliability MCS table (with an MCS index of “20”) to perform modulation and coding on a physical channel.

In some of the present implementations, the content of a PSCCH may be inherited from a PDCCH. Therefore, the MCS related information contained in the SCI may be the same as the MCS related information contained in the DCI.

In some of the present implementations, SL-V-RNTI-U may be a UE-specific configured parameter, and a UE may try to decode a PSSCH based on the SL-V-RNTI-U (if the UE is configured with the SL-V-RNTI-U). In some of the present implementations, the SL-V-RNTI-U may be a UE-specific and resource pool specific configured parameter, and a UE may try to decode a PSSCH based on the SL-V-RNTI-U if the UE attempts to receive a PSCCH in the resource pool configured with the SL-V-RNTI-U.

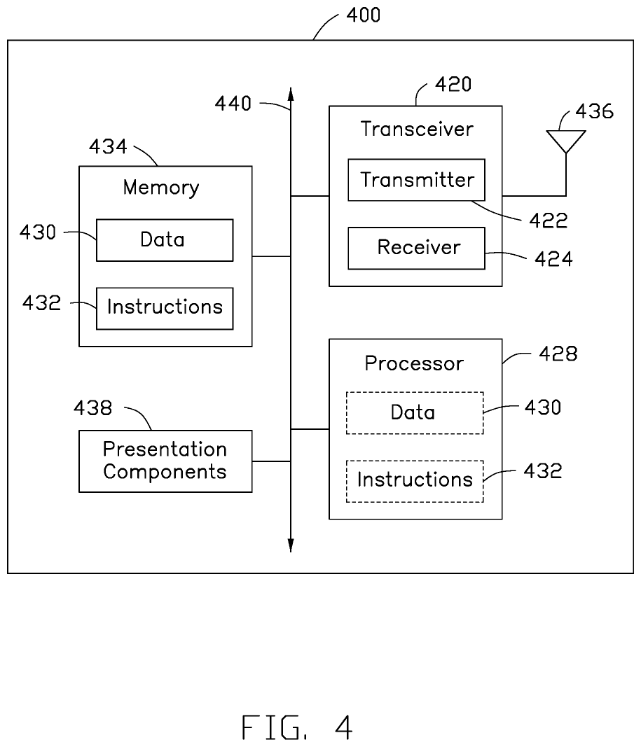

FIG. 4 is a block diagram illustrating a node for wireless communication, in accordance with various aspects of the present disclosure. As shown in FIG. 4, a node 400 may include a transceiver 420, a processor 428, a memory 434, one or more presentation components 438, and at least one antenna 436. The node 400 may also include an RF spectrum band module, a BS communications module, a network communications module, and a system communications management module, Input/Output (I/O) ports, I/O components, and power supply (not explicitly shown in FIG. 4). Each of these components may be in communication with each other, directly or indirectly, over one or more buses 440. In one implementation, the node 400 may be a UE or a BS that performs various functions described herein, for example, with reference to FIGS. 1 through 3.

The transceiver 420 having a transmitter 422 (e.g., transmitting/transmission circuitry) and a receiver 424 (e.g., receiving/reception circuitry) may be configured to transmit and/or receive time and/or frequency resource partitioning information. In some implementations, the transceiver 420 may be configured to transmit in different types of subframes and slots including, but not limited to, usable, non-usable and flexibly usable subframes and slot formats. The transceiver 420 may be configured to receive data and control channels.

The node 400 may include a variety of computer-readable media. Computer-readable media may be any available media that may be accessed by the node 400 and include both volatile and non-volatile media, removable and non-removable media. By way of example, and not limitation, computer-readable media may comprise computer storage media and communication media. Computer storage media includes both volatile and non-volatile, removable and non-removable media implemented in any method or technology for storage of information such as computer-readable instructions, data structures, program modules or data.

Computer storage media includes RAM, ROM, EEPROM, flash memory or other memory technology, CD-ROM, Digital Versatile Disks (DVD) or other optical disk storage, magnetic cassettes, magnetic tape, magnetic disk storage or other magnetic storage devices.

Computer storage media does not comprise a propagated data signal. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The memory 434 may include computer-storage media in the form of volatile and/or non-volatile memory. The memory 434 may be removable, non-removable, or a combination thereof. Example memory includes solid-state memory, hard drives, optical-disc drives, and etc. As illustrated in FIG. 4, The memory 434 may store computer-readable, computer-executable instructions 432 (e.g., software codes) that are configured to, when executed, cause the processor 428 to perform various functions described herein, for example, with reference to FIGS. 1 through 3. Alternatively, the instructions 432 may not be directly executable by the processor 428 but be configured to cause the node 400 (e.g., when compiled and executed) to perform various functions described herein.

The processor 428 (e.g., having processing circuitry) may include an intelligent hardware device, e.g., a Central Processing Unit (CPU), a microcontroller, an ASIC, and etc. The processor 428 may include memory. The processor 428 may process the data 430 and the instructions 432 received from the memory 434, and information through the transceiver 420, the base band communications module, and/or the network communications module. The processor 428 may also process information to be sent to the transceiver 420 for transmission through the antenna 436, to the network communications module for transmission to a core network.

One or more presentation components 438 presents data indications to a person or other device. Examples of presentation components 438 may include a display device, speaker, printing component, vibrating component, etc.

From the above description, it is manifested that various techniques may be used for implementing the concepts described in the present application without departing from the scope of those concepts. Moreover, while the concepts have been described with specific reference to certain implementations, a person of ordinary skill in the art may recognize that changes may be made in form and detail without departing from the scope of those concepts. As such, the described implementations are to be considered in all respects as illustrative and not restrictive. It should also be understood that the present application is not limited to the particular implementations described above, but many rearrangements, modifications, and substitutions are possible without departing from the scope of the present disclosure.

What is claimed is:

1. A user equipment (UE) comprising:
one or more non-transitory computer-readable media having computer-executable instructions embodied thereon; and
at least one processor coupled to the one or more non-transitory computer-readable media, and configured to execute the computer-executable instructions to:
receive, from a base station (BS), a Radio Resource Control (RRC) configuration containing a carrier-specific Bandwidth Part (BWP) configuration;
receive, from the BS, Downlink Control Information (DCI) indicating a Sidelink (SL) BWP associated with the carrier-specific BWP configuration in a carrier; and
perform SL operations on the SL BWP based on the carrier-specific BWP configuration.

2. The UE of claim 1, wherein the DCI comprises an indicator for determining a number of repetitions of an SL physical channel.

3. The UE of claim 2, wherein the at least one processor is further configured to execute the computer-executable instructions to:
obtain a threshold that is one of preconfigured in the UE and configured by the BS; and
determine the number of repetitions of the SL physical channel based on a comparison between the threshold and the indicator.

4. The UE of claim 1, wherein the DCI comprises an indicator for determining a Modulation Coding Scheme (MCS) table, and the at least one processor is further configured to execute the computer-executable instructions to:
obtain a threshold which is preconfigured in the UE or configured by the BS; and
determine the MCS table based on a comparison between the threshold and the indicator; and
perform modulation and coding for an SL physical channel based on the MCS table.

5. The UE of claim 1, wherein the at least one processor is further configured to execute the computer-executable instructions to:
perform modulation and coding for an SL physical channel based on an MCS table;
wherein the MCS table is configured by the BS per one of a resource pool basis and an anchor carrier basis.

6. The UE of claim 1, wherein the at least one processor is further configured to execute the computer-executable instructions to:
update at least one of a Tracking Reference Signal (TRS) pattern and a Demodulation Reference Signal (DMRS) pattern contained in the RRC configuration based on the DCI.

7. The UE of claim 6, wherein the TRS pattern comprises time and frequency domain resource allocations of a set of TRSs, and the DMRS pattern comprises time and frequency domain resource allocations of a set of DMRSs.

8. The UE of claim 1, wherein the at least one processor is further configured to execute the computer-executable instructions to:
apply a spatial domain filter which is used for receiving a Physical Downlink Control Channel (PDCCH) containing the DCI to perform the SL operations.

9. The UE of claim 1, wherein the RRC configuration comprises a plurality of Reference Signal (RS) settings for the SL operations, and each of the plurality of RS settings is configured per one of a resource pool basis and an anchor carrier basis.

10. The UE of claim 9, wherein the plurality of RS settings comprises at least one of a DMRS setting, a Phase Tracking Reference Signal (PTRS) setting, and a TRS setting.

11. The UE of claim 1, wherein the at least one processor is further configured to execute the computer-executable instructions to:
determine an MCS table based on a type of a Radio Network Temporary Identifier (RNTI) scrambling the DCI; and
perform modulation and coding for an SL physical channel based on the MCS table.

12. A method performed by a user equipment (UE), the method comprising:
receiving, from a base station (BS), a Radio Resource Control (RRC) configuration containing a carrier-specific Bandwidth Part (BWP) configuration;
receiving, from the BS, Downlink Control Information (DCI) indicating a Sidelink (SL) BWP associated with the carrier-specific BWP configuration in a carrier; and
performing SL operations on the SL BWP based on the carrier-specific BWP configuration.

13. The method of claim 12, wherein the DCI comprises an indicator for determining a number of repetitions of an SL physical channel.

14. The method of claim 13, further comprising:
obtaining a threshold that is one of preconfigured in the UE and configured by the BS; and
determining the number of repetitions of the SL physical channel based on a comparison between the threshold and the indicator.

15. The method of claim 12, wherein the DCI comprises an indicator for determining a Modulation Coding Scheme (MCS) table, and the method further comprises:
obtaining a threshold which is preconfigured in the UE or configured by the BS; and
determining the MCS table based on a comparison between the threshold and the indicator; and
performing modulation and coding for an SL physical channel based on the MCS table.

16. The method of claim 12, further comprising:
performing modulation and coding for an SL physical channel based on an MCS table;
wherein the MCS table is configured by the BS per one of a resource pool basis and an anchor carrier basis.

17. The method of claim 12, further comprising:
updating at least one of a Tracking Reference Signal (TRS) pattern and a Demodulation Reference Signal (DMRS) pattern contained in the RRC configuration based on the DCI.

18. The method of claim 17, wherein the TRS pattern comprises time and frequency domain resource allocations of a set of TRSs, and the DMRS pattern comprises time and frequency domain resource allocations of a set of DMRSs.

19. The method of claim 12, further comprising:
applying a spatial domain filter which is used for receiving a Physical Downlink Control Channel (PDCCH) containing the DCI to perform the SL operations.

20. The method of claim 12, wherein the RRC configuration comprises a plurality of Reference Signal (RS) settings for the SL operations, and each of the plurality of RS settings is configured per one of a resource pool basis and an anchor carrier basis.

21. The method of claim 20, wherein the plurality of RS settings comprises at least one of a DMRS setting, a Phase Tracking Reference Signal (PTRS) setting, and a TRS setting.

22. The method of claim 12, further comprising:
determining an MCS table based on a type of a Radio Network Temporary Identifier (RNTI) scrambling the DCI; and
performing modulation and coding for an SL physical channel based on the MCS table.
